(19) United States
(12) Patent Application Publication
(10) Pub. No.: US 2025/0159590 A1
(43) Pub. Date: May 15, 2025

(54) EFFICIENT DESIGN OF A SUPPLEMENTARY BEACON FOR WI-FI NETWORKS

(71) Applicant: HEWLETT PACKARD ENTERPRISE DEVELOPMENT LP, Spring, TX (US)

(72) Inventors: Abhiruchi Dakshinkar, San Jose, CA (US); Gaurav Patwardhan, San Jose, CA (US); Eldad Perahia, Park City, UT (US); Sachin Ganu, San Jose, CA (US); Nitin A. Changlani, Milpitas, CA (US)

(21) Appl. No.: 18/835,601

(22) PCT Filed: Feb. 8, 2023
(86) PCT No.: PCT/US2023/062199

§ 371 Date: Aug. 2, 2024

Related U.S. Application Data
(60) Provisional application No. 63/308,528, filed on Feb. 10, 2022.

(51) Int. Cl. H04W 48/12; H04L 5/00; H04W 76/30

(52) U.S. Cl. CPC H04W 48/12; H04L 5/0048; H04W 76/30

(57) ABSTRACT

The present disclosure describes examples of the mechanism of a Supplemental Beacon. The Supplemental Beacon may be used as an additional beacon to an original main beacon in a Wi-Fi system. The Supplemental Beacon may be transmitted in a Short Interframe Space (SIFS) interval preceding the transmittance of the main beacon. Establishing set times of the Supplemental Beacon transmittance before the main beacon may allow client devices to wake up at consistent time intervals to receive data, and allow client devices to only remain awake for a short duration between the Supplemental Beacon transmittance and the main beacon transmittance before going back to sleep. The support of a Supplemental Beacon to the main beacon at fixed times of short duration before the main beacon that may allow the conservation of power of client devices and network devices in the Wi-Fi system, and increase productivity in the transmission of data.

### CROSS-REFERENCE TO RELATED APPLICATIONS

This application claims the benefit of and priority to U.S. Provisional Patent Application No. 63/308,528, filed on Feb. 10, 2022, the contents of which is incorporated herein by reference in its entirety.

### DESCRIPTION OF RELATED ART

Improvements in Wireless technologies are always needed. In particular, the adoption of the more recent 802.11 Institute of Electrical and Electronics Engineers (IEEE) standards, and how to interact with legacy clients, can be improved.

### BRIEF DESCRIPTION OF THE DRAWINGS

The present disclosure, in accordance with one or more various examples, is described in detail with reference to the following figures. The figures are provided for purposes of illustration only and merely depict typical or example examples.

FIG. 1 illustrates one example of a network configuration that may be implemented for an organization, such as a business, educational institution, governmental entity, healthcare facility or other organization.

FIG. 2 illustrates an example beacon transmission, in accordance with one or more examples.

FIG. 3 illustrates an example beacon transmission, in accordance with one or more examples.

FIG. 4 illustrates an example beacon transmission, in accordance with one or more examples.

FIG. 5 illustrates an example beacon transmission, in accordance with one or more examples.

FIGS. 6A and 6B illustrates an example beacon transmission, in accordance with one or more examples.

FIG. 7 illustrates an example computing component that may be used to implement various features for Supplemental beacons in accordance with one example of the disclosed technology.

FIG. 8 illustrates an example block diagram of a computer system in which various of the examples described herein may be implemented.

The figures are not exhaustive and do not limit the present disclosure to the precise form disclosed.

### DETAILED DESCRIPTION

Multiple Basic Service Set Identifiers (BSSID) beacon support was introduced as a mandatory Wi-Fi Alliance (WFA) feature for clients as part of the 802.11ax specification. Legacy (pre-802.11ax) devices operate in the 2.4 GHz and 5 GHz frequency bands. Only 802.11ax capable devices operate in the 6 GHz frequency band. Multiple BSSID beacons would be widely deployed for a 6 GHz radio, but legacy devices are not allowed on the 6 GHz frequency band. Though Access Points (AP) can use multiple BSSID beacons on the 2.4 GHz and 5 GHz frequency bands, the deployment will be restricted due to the presence of legacy devices of clients.

Today, enterprise APs can claim support for up to 16 Virtual Access Points (VAPs). Each VAP may advertise different capabilities such as 802.11r, 802.11k etc. Advertising all of the VAPs in a beacon may lead to beacon size bloating. There is a limitation on the maximum beacon size supported for management frames, which is currently around 1500 bytes. Given the beacon size limitation, it is not possible to advertise all of the VAPs of a radio in a single beacon.

The 802.11ax specification provides a mechanism called Enhanced Multiple BSSID (EMA) advertising to deal with beacon content that exceeds a given beacon size limitation, also referred to as overflowing beacon content. Though EMA advertising is a mandatory feature in the 802.11ax specification, it is not mandated by any WFA test. As a result, multiple client and AP vendors have decided not to support the feature. The concept of multiple BSSID sets has been proposed to deal with large numbers of VAPs. Multiple BSSID sets entail dividing VAPs on a radio into groups (sets), and a beacon is sent out by the AP for each of these sets. Each set will have one transmitted VAP, and one or more non-transmitted VAPs such that a specified beacon length (size limitation) is not exceeded.

Longer beacons entail higher power consumption at the stations of a Wi-Fi system. To solve the problem of beacon bloating and address power optimization in beacon processing, a mechanism referred to as a “Follow-On beacon” has been previously proposed. The idea is to send an additional beacon as an addendum to the original primary beacon. The transmission time and characteristics of the Follow-On beacon may be captured in a new “Follow on IE” that may be transmitted in the original beacon. The idea may be implemented in the 2.4/5/6 GHz frequency bands. Legacy clients may interpret a legacy beacon. Stations that understand the Follow-On IE (Information Elements) will be able to interpret the Follow-On beacon.

The Follow-On beacon includes extra beacon information that follows the primary beacon to which it is associated. The Follow-On beacon follows the primary beacon after an “offset” time. The offset time can be any variable amount of time after a first primary beacon (the primary beacon with which the Follow-On beacon is associated) up until before the second primary beacon (the next primary beacon after the first), as the offset times is not fixed.

Thus, while the use of Follow-On beacons can be used advantageously to support newer client devices, there are also disadvantages. Client devices of client vendors are typically “asleep” in between each primary beacon, and tend to wake up at a time interval corresponding to each primary beacon to receive data being transmitted between Access Point (AP) vendors from network devices and the client vendors from client devices. The time between each primary beacon may be a set value that is programmed and client devices have information of the set time between each primary beacon so that the client devices may wake up precisely when they need to. Allowing client devices to be asleep between primary beacons and only wake up at the times when the primary beacons are active allows for the conservation of energy.

Since a Follow-On beacon is transmitted after its associated primary beacon, at some variable offset time after transmission of the primary beacon, newer client devices (meaning “non-legacy” devices of client vendors) and network devices of AP vendors may not know when to wake up to receive data being transmitted from the Follow-On beacon since the offset time between the Follow-On beacon and the primary beacon is not fixed. Thus, using Follow-On beacons will force newer client devices to wake up at the set time of each primary beacon and remain awake until the offset time for the Follow-On beacon is reached in order to ensure the newer client devices receive data from the Follow-On beacon before going back to sleep and having to wake up again at the time of the next primary beacon. This will cause the newer client devices to be awake for longer durations, thus causing greater power consumption of energy in the client devices.

Examples of the disclosed technology are directed to a Supplemental beacon mechanism. The Supplemental beacon can be used as an addendum to the primary beacon to support newer client devices of client vendors that operate in accordance with the 802.11ax specification. Unlike the above-described Follow-On beacon, however, transmission of a Supplemental beacon occurs at a fixed time preceding its associated primary beacon. In this way, client devices are aware of the timing of each Supplemental beacon and primary beacon, allowing newer client devices, which are typically “asleep” in between each primary beacon, to wake up at the correct time(s) to receive data. In addition, transmitting the Supplemental beacon at a fixed time preceding its associated primary beacon, newer client devices may only need to remain awake for shorter durations of time. Thus, the Supplemental beacon may replace the Follow-On beacon to support the primary beacon. The Supplemental beacon has the same advantages as the Follow-On beacon while curing its disadvantages. The Supplemental beacon may allow for a greater conservation of power, increase in productivity in the transmission of data, and provide greater positive user experience to client vendors using the newer client devices. Examples of the present disclosure will be described below.

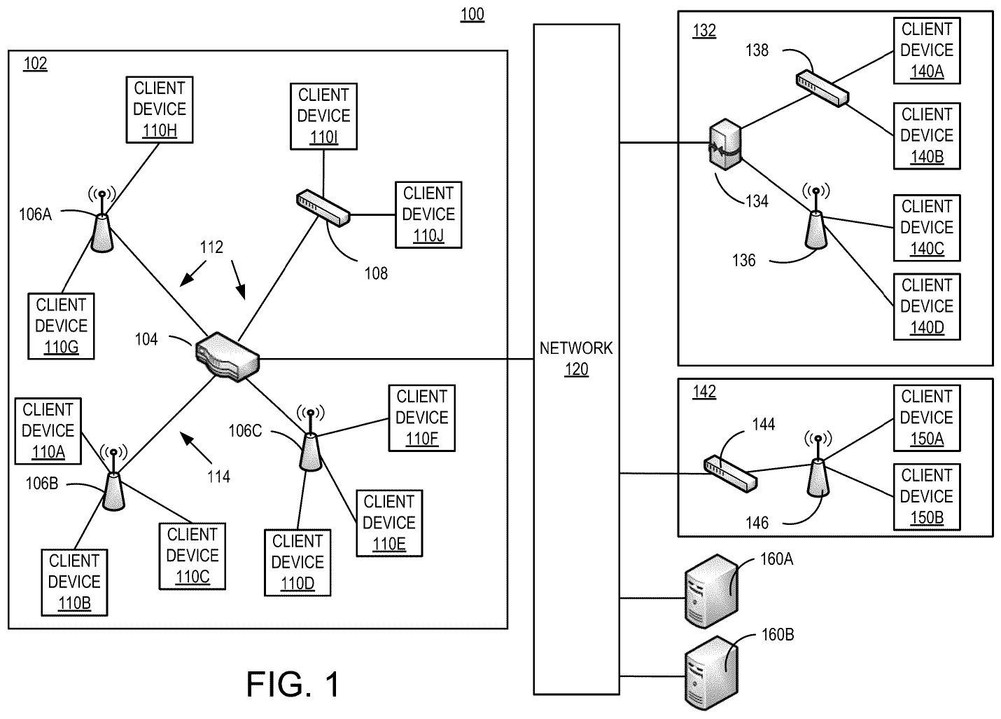

Before describing examples of the disclosed systems and methods in detail, it is useful to describe an example network installation with which these systems and methods might be implemented in various applications. FIG. 1 illustrates one example of a network configuration 100 that may be implemented for an organization, such as a business, educational institution, governmental entity, healthcare facility or other organization. The organization of the network configuration 100 may include multiple users (or at least multiple client devices 110) and possibly multiple physical or geographical sites, such as primary site 102, remote site 132, and remote site 142. The network configuration 100 may include a primary site 102 in communication with a network 120. The network configuration 100 may also include one or more remote sites 132, 142, that are in communication with the network 120. The network 120 may allow each geographical site of the network configuration 100 of an organization to communicate with one another.

The primary site 102 may include a primary network, which can be, for example, an office network, home network or other network installation. The network of the primary site 102 may be a private network, such as a network that may include security and access controls to restrict access to authorized users of the private network. Authorized users may include, for example, employees of a company at primary site 102, residents of a house, customers at a business, and so on.

In the illustrated example, the primary site 102 includes a controller 104 in communication with the network 120. The controller 104 may provide communication with the network 120 for the primary site 102, though the controller 104 may not be the only point of communication with the network 120 for the primary site 102. A single controller 104 is illustrated, though the primary site 102 may include multiple controllers and/or multiple communication points with network 120. In some examples, the controller 104 communicates with the network 120 through a router (not illustrated). In other examples, the controller 104 provides router functionality to the devices, such as client devices 110, in the primary site 102.

A controller 104 may be operable to configure and manage network devices, such as at the primary site 102, and may also manage network devices, such as gateway device 134, AP 136, switch 138, gateway device 144 and AP 146, at the remote sites 132, 142. The controller 104 may be operable to configure and/or manage switches, routers, access points, and/or client devices connected to a network. The controller 104 may itself be, or provide the functionality of, an Access Point (AP).

The controller 104 may be in communication with one or more switches 108 and/or wireless Access Points (APs) 106A-C. Switches 108 and wireless APs 106A-C may provide network connectivity to various client devices 110A-J. Using a connection to a switch 108 or AP 106A-C, a client device of client devices 110A-J may access network resources, including other devices on the network of primary site 102 and the network 120.

Examples of client devices may include: desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, Internet of Things (IoT) devices, and the like. Client vendors may connect to the network of the primary site 102, the network of the remote site 132, and/or the network of the remote site 142 an organization using client devices, such as client devices 110A-J, client devices 140A-D, and/or client devices 150A-B.

Within the primary site 102, a switch 108 is included as one example of a point of access to the network established in primary site 102 for wired client devices 1101-J. Client devices 1101-J may connect to the switch 108 and through the switch 108, may be able to access other devices within the network configuration 100. The client devices 1101-J may also be able to access the network 120, through the switch 108. The client devices 1101-J may communicate with the switch 108 over a wired 112 connection. In the illustrated example, the switch 108 communicates with the controller 104 over a wired 112 connection, though this connection may also be wireless.

Wireless APs 106A-C are included as another example of a point of access to the network established in primary site 102 for client devices 110A-H. Each of APs 106A-C may be a combination of hardware, software, and/or firmware that is configured to provide wireless network connectivity to wireless client devices 110A-H. In the illustrated example, APs 106A-C can be managed and configured by the controller 104. APs 106A-C may communicate with the controller 104 and the network of primary site 102 over connections 112, which may be either wired or wireless interfaces.

The network configuration 100 may include one or more remote sites, such as remote site 132. Remote site 132 may be located in a different physical or geographical location from the primary site 102. In some cases, the remote site 132 may be in the same geographical location, or possibly the same building, as the primary site 102, but lacks a direct connection to the network of the primary site 102. Instead, remote site 132 may utilize a connection over a different network, e.g., network 120, to connect to the network of the primary site 102. The remote site 132 may be, for example, a satellite office, another floor or suite in a building, and so on. The remote site 132 may include a gateway device 134 for communicating with the network 120. A gateway device 134 may be a router, a digital-to-analog modem, a cable modem, a Digital Subscriber Line (DSL) modem, or some other network device configured to communicate to the network 120. The remote site 132 may also include a switch 138 and/or AP 136 in communication with the gateway device 134 over either wired or wireless connections. The switch 138 and AP 136 may provide connectivity to the network for various client devices 140A-D.

In various examples, the remote site 132 may be in direct communication with the primary site 102, such that client devices 140A-D at the remote site 132 access the network resources at the primary site 102 as if clients devices 140A-D were located at the primary site 102. In such examples, the remote site 132 may be managed by the controller 104 at the primary site 102, and the controller 104 may provide the necessary connectivity, security, and accessibility that enables the communication of the remote site 132 with the primary site 102. Once connected to the primary site 102, the remote site 132 may function as a part of a private network provided by the primary site 102.

In various examples, the network configuration 100 may include one or more smaller remote sites, such as remote site 142, comprising only a gateway device 144 for communicating with the network 120 and a wireless AP 146, by which various client devices 150A-B may access the network 120. Such a remote site 142 may represent, for example, an individual employee's home or a temporary remote office. The remote site 142 may also be in communication with the primary site 102, such that the client devices 150A-B at remote site 142 access network resources at the primary site 102 as if these client devices 150A-B were located at the primary site 102. The remote site 142 may be managed by the controller 104 at the primary site 102 to make this transparency possible. Once connected to the primary site 102, the remote site 142 may function as a part of a private network provided by the primary site 102.

The network 120 may be a public or private network, such as the Internet, or other communication network to allow connectivity among the various sites 102, 132 and 142 as well as access to servers, such as servers 160A-B. The network 120 may include third-party telecommunication lines, such as phone lines, broadcast coaxial cable, fiber optic cables, satellite communications, cellular communications, and the like. The network 120 may include any number of intermediate network devices, such as switches, routers, gateways, servers, and/or controllers, which are not directly part of the network configuration 100 but that facilitate communication between the various parts of the network configuration 100, and between the network configuration 100 and other network-connected entities. The network 120 may include various content servers such as servers 160A-B. Content servers 160A-B may include various providers of multimedia downloadable and/or streaming content, including audio, video, graphical, and/or text content, or any combination thereof. Examples of content servers 160A-B may include, for example, web servers, streaming radio and video providers, and cable and satellite television providers. The client devices 110A-J, 140A-D, 150A-B may request and access the multimedia content provided by the content servers 160A-B through the network 120.

Returning to the present invention, in current implementations, beacons for a radio may be transmitted in one of the following ways:

1. Independent beacons: One beacon may be used per VAP, where the transmitter address (TA) of the beacon may be the BSSID address of the VAP for the beacon.

2. Multiple BSSIDs per beacon: A single beacon may advertise multiple VAPs, such as having all of the VAPs of a radio advertised in a single beacon. The transmitter address (TA) of the beacon may be the BSSID of the VAP being transmitted.

3. Multiple BSSID sets: The VAPs of a radio may be divided into multiple sets and a beacon may be transmitted for each set of VAPs. Each set of VAPs may have a transmitted VAP and one or more non-transmitted VAPs. The transmitter address (TA) of the beacon may be the BSSID of the corresponding transmitted VAP of the Multiple BSSID (MBSSID) set.

### Follow-on Beacon;

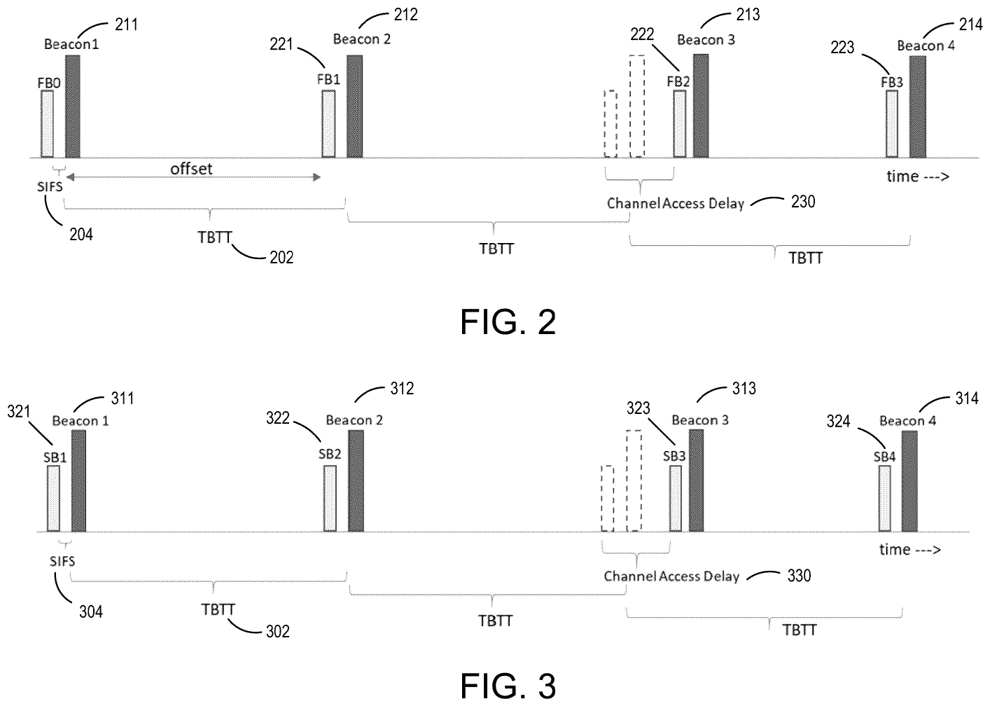

FIG. 2 illustrates a Follow-On beacon. Specifically, FIG. 2 shows the independent primary beacon case with a single VAP per radio. The primary beacons Beacon1 211, Beacon2 212, Beacon3 213, and Beacon4 214 may be the beacons transmitted at set time intervals, such as a Target Beacon Transmission Time (TBTT) 202, by a single VAP for each primary beacon. A Follow-On beacon (FB) may be associated with a primary beacon. For example, Follow-On beacon FB1 221 may be associated with primary beacon Beacon1 211, Follow-On beacon FB2 222 with primary beacon Beacon2 212, Follow-On beacon FB3 223 with primary beacon Beacon3 213, and so on. A Follow-On beacon may be transmitted at an offset time after the associated primary beacon. The offset time of the Follow-On beacon may not be a set time after the associated primary beacon, and may vary. The Follow-On beacon may be an offset time after the associated primary beacon so that the time between the Follow-On beacon and the next primary beacon is a time interval of Short Interframe Space (SIFS) 204.

The primary beacon Beacon3 213 is an example of a case where the transmission of a beacon (and the previous Follow-On beacon) is delayed due to channel access delay 230. As illustrated in FIG. 2, there may be no channel access delays in the transmission of the primary beacons Beacon2 212 and Beacon4 214. The channel access delay of a primary beacon, such as Beacon3 213, and of a previous Follow-On beacon, such as FB2 222, may not affect the transmission time of the primary beacon Beacon4 214 and the Follow-On beacon FB3 223. While not illustrated in FIG. 2, channel access delay can impact the time interval between successive beacons of a VAP if a staggered beacon approach is used.

The Follow-On beacon may be transmitted at an offset time after the associated primary beacon. From a client's perspective, AP capabilities may be assessed after processing the primary beacon and the associated Follow-On beacon. In the above design illustrated in FIG. 2, the station can parse all the capabilities of the AP only at the end of TBTT 202 after processing the primary beacon and the associated Follow-On beacon. This may cause beacon bloating and greater energy consumption in both network devices and client devices. To overcome this issue, the concept of Supplementary beacon is proposed.

### Supplementary Beacon:

FIG. 3 illustrates an example independent primary beacon case with a single VAP per radio, thus a single VAP is used for each beacon transmitting data as a single beacon packet. The primary beacons Beacon1 311, Beacon2 312, Beacon3 313, and Beacon4 314 may be beacons transmitted at set time intervals, such as TBTT 302. Each of the primary beacons Beacon1 311, Beacon2 312, Beacon3 313, and Beacon4 314 may by transmitted by a single VAP per radio. Each primary beacon may be associated with a Supplemental beacon. For example, Supplemental beacon SB1 321 may be associated with primary beacon Beacon1 311, Supplemental beacon SB2 322 for primary beacon Beacon2 312, Supplemental beacon SB3 323 for primary beacon Beacon3 313, Supplemental beacon SB4 324 for primary beacon Beacon4 314, and so on. A Supplementary beacon may be transmitted at a set time interval, such as SIFS 304, preceding the associated primary beacon.

Primary beacon Beacon3 313 may be an example of a case where the transmission of the primary beacon (and the associated Supplementary beacon) is delayed due to channel access delay 330. As illustrated in FIG. 2, there may be no channel access delays in the transmission of the primary beacons Beacon2 312 and Beacon4 314. The channel access delay of a primary beacon, such as Beacon3 313, and of the associated Supplemental beacon, such as SB3 323, may not affect the transmission time of the primary beacon Beacon4 314 and the Supplemental beacon SB4 324. While not illustrated in FIG. 2, channel access delay can impact the time interval between successive beacons of a VAP if a staggered beacon approach is used.

Each Supplemental beacon SB1 321, SB2 322, SB3 323, and SB4 324 may transmit data to one or more client devices in the network. The data transmitted by a Supplemental beacon may be a portion of the overall data to be transmitted by the associated primary beacon. The primary beacon may be used to transmit data to legacy client devices. Legacy client devices may have limited capabilities to receive and/or process certain data, whether the data is too large or too complex for the legacy client devices to handle. Such large or complex data may cause legacy client devices to fail. The Supplemental beacon may be used to separate data for newer (“non-legacy”) client devices to allow all client devices to receive the data relevant to them while not causing any client devices to fail. Having a Supplemental beacon transmit at a set time interval, such as SIFS 304, preceding the associated primary beacon may also allow client devices to wake up at set times to receive data, and to only remain awake for short periods of time. This may provide an increase in productivity in transmitting data to client devices along while decreasing the consumption of power of client devices and decrease the likelihood of failures of client devices, in particularly legacy client devices.

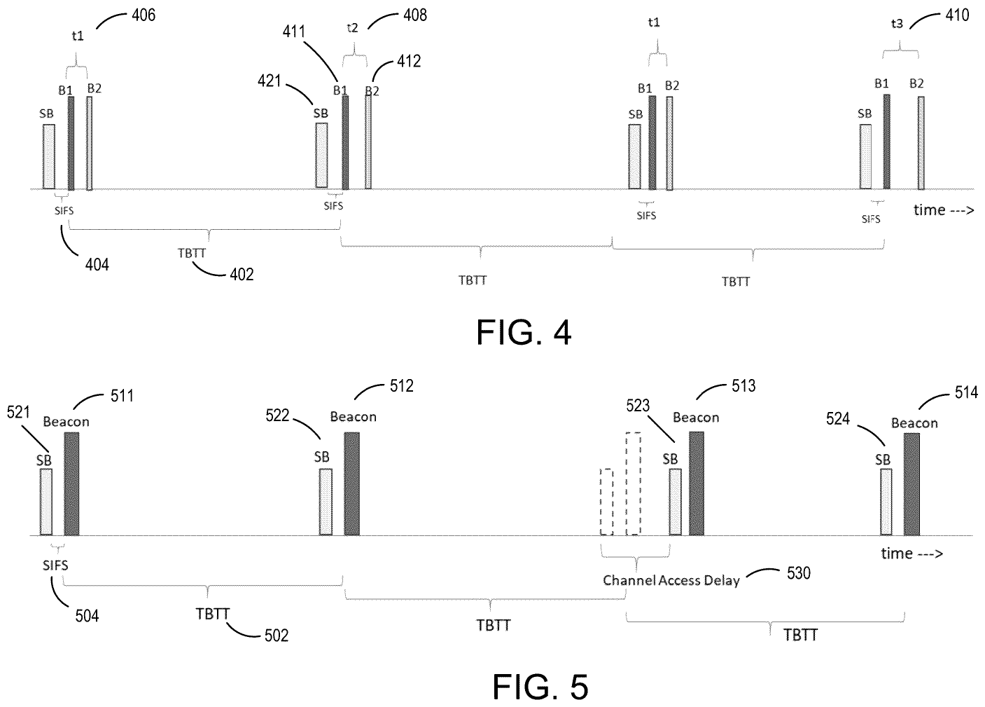

FIG. 4 illustrates an example case where there are two VAPs per radio, with each VAP being used to transmit a separate beacon as a different beacon packet. The case of FIG. 4 may be extended to multiple VAP scenarios. Primary beacon, such as B1 411, may represent the beacon transmitted by a first VAP. Primary beacon, such as B2 412, may represent the beacon transmitted by a second VAP. The primary beacons of B1 411 and B2 412 may be in a primary beacon set, with the primary beacon set having a single associated Supplemental beacon, such as SB 421, to be used for all of the primary beacons B1 and B2 within the primary beacon set. In some examples, the time between the primary beacons Bland B2 of a primary beacon set may be at different time intervals, t1 406, t2 408 or t3 410. In other examples, the time of t1 406, t2 408 and/or t3 410 may be at a set time interval, such as SIFS. The time intervals t1 406, t2 408, and t3 410 between beacon transmissions highlight the possibility of staggered beacons in primary beacon sets. The SIFS time interval between primary beacons B1 and B2 may be used for a bursted beacon approach. Each primary beacon set may comprise of beacons, such as B1 411 and B2 412, that are transmitted at set time intervals, such as TBTT 402, apart from each other primary beacon set. A Supplementary beacon, such as SB 421, may be transmitted at a set time interval, such as SIFS 404, preceding the first primary beacon of the associated primary beacon set. Many variations are possible.

The VAPs of a radio may be co-hosted. A co-hosted set of VAPs is a collection of access points (APs) such that all APs use a common operating class, channel, receive antenna connector, and transmit antenna connector and each AP advertises information for its BSSID using Beacon or Probe Response frames. The Transmitter address (TA) of a primary beacon could be BSSID of the VAP being used for that particular primary beacon, or the TA may be any single fixed VAP in the co-hosted set. As an example, if there are 2\hat{ } n VAPs in a co-hosted set, this means 48-n bits of the BSSID for the co-hosted set are identical. The TA of the beacon may be the 48-n bits with the last n bits set to zero. The client devices may process the frame using a criterion: Frame from co-hosted VAP and specific frame type (Supplementary beacon).

A single Supplemental beacon may be used for all of the VAPs of a radio, thus for each of the primary beacons being transmitted. The offset time definition in this example of the Supplemental beacon is the interval of time prior to the primary beacon associated to the Supplementary beacon being transmitted. The Supplementary beacon, such as SB 421, may be transmitted at an offset time interval, such as SIFS 404, prior to the first primary beacon for the radio, such as primary beacon B1 411.

The Supplementary beacon contents/IEs may be advertised using the inheritance principle introduced by MBSSID. A common section of a primary beacon may carry IEs corresponding to the VAP whose BSSID is the TA of the beacon. A new IE could be used to encapsulate the information of the subsequent VAPs. The concept of BSSID index relative to the transmitted VAP can then be extended to identify the VAP whose information is encapsulated in the new IE. In addition, the Supplementary beacon IE may identify the Basic Service Set (BSS) advertised in the Supplementary beacon. This way, only stations and client devices associated to the corresponding BSS would wake up to process the Supplementary beacon in the network.

Due to the limitation of management frame size, there may a possibility of multiple Supplementary beacons per radio. The offset in Supplementary Beacon IE along with the BSSID may help stations and client devices to process the right Supplementary beacon when there are multiple Supplementary beacons. A token may be used to link a primary beacon to a Supplementary beacon by being added as part of Supplementary Beacon IE. The token may be important in that the token may be used to allow client devices and stations to process the correct primary beacon(s) and Supplementary beacon(s) in coherence to register the capabilities advertised by a given AP.

In some examples, beacon transmission by a radio advertising multiple VAPs could be staggered or bursted. Bursted implies a radio accesses the medium and all the beacons are transmitted at a time interval of SIFS apart. Staggered implies a fresh channel access attempted per beacon transmission. These beacon transmission methods of bursted and staggered are not defined in the 802.11 standard, and may be implementation dependent. Other various methods may also be chosen by different vendors.

For bursted beacons, the offset time advertised in the Supplementary beacon IE of the Supplemental beacon may be a function of order of beacon transmission, the channel access delay for first beacon, the size of the Supplementary beacon and a number of Supplementary beacons. Most enterprise APs support the bursted beacon approach as the bursted beacon approach results in deterministic beacon transmissions. For staggered beacons, the offset time advertised in the Supplementary beacon IE of the Supplemental beacon may be a function of channel access delay for every primary beacon, order of beacon transmission, size of the Supplementary beacon and number of Supplementary beacons. For either beacon transmission method, the Supplementary beacon(s) may be transmitted at a set time interval, such as SIFS 304, preceding the first primary beacon, such as B1 411, of the radio.

Each Supplemental beacon, such as SB 421, may transmit data to one or more client devices in the network. The data transmitted by a Supplemental beacon may be a portion of the overall data to be transmitted by the associated primary beacons B1 411 and B2 412. The primary beacons B1 411 and B2 412 may be used to transmit data to legacy client devices. Legacy client devices may have limited capabilities to receive and/or process certain data, whether the data is too large or too complex for the legacy client devices to handle. Such large or complex data may cause legacy client devices to fail. The Supplemental beacon SB 421 may be used to separate data for newer (“non-legacy”) client devices to allow all client devices to receive the data relevant to them while not causing any client devices to fail. Legacy devices may detect the transmitted VAPs of the primary beacons, but may ignore the Supplemental beacons and any VAPs being transmitted by the Supplemental beacons. The newer client devices may process the Supplemental beacons and receive data and VAPs being transmitted by the Supplemental beacons.

Having a Supplemental beacon, such as SB 421, transmit at a set time interval, such as SIFS 404, preceding the associated primary beacon may also allow client devices to wake up at set times to receive data, and to only remain awake for short periods of time. This may provide an increase in productivity in transmitting data to client devices along while decreasing the consumption of power of client devices and decrease the likelihood of failures of client devices, in particularly legacy client devices.

### Supplementary Beacon for Multiple MBSSID Sets

FIG. 5 illustrates an example of single MBSSID set beacons. Each primary beacon in FIG. 5, such as beacon 511, beacon 512, beacon 513 and beacon 514, may represent a single MBSSID set beacon. A single MBSSID set beacon may comprise more than one VAP. A MBSSID set beacon may be used for multiple VAPs when the number of total bytes amongst the VAPs of a radio being advertised does not exceed a byte threshold. In some examples, the byte threshold of a single MBSSID set beacon is 1500 bytes. When having a total bytes of all of the VAPs of a radio being advertised does not exceed the byte threshold of a MBSSID set beacon, then only a single MBSSID set beacon may be used for all of the VAPs. Each single MBSSID set beacon may have an associated Supplemental beacon. For example, Supplemental beacon SB 521 may be associated with the single MBSSID set beacon 511, Supplemental beacon SB 522 for single MBSSID set beacon 512, Supplemental beacon SB 523 for single MBSSID set beacon 513, Supplemental beacon SB 524 for single MBSSID set beacon 514, and so on. A Supplementary beacon, such as SB 521, may be transmitted at a set time interval, such as SIFS 504, preceding the associated single MBSSID set beacon, such as beacon 511.

The single MBSSID set beacon 513 may be an example of a case where the transmission of the primary beacon (and the associated Supplementary beacon) is delayed due to channel access delay 530. As illustrated in FIG. 5, there may be no channel access delays in the transmission of the single MBSSID set beacon 512 and single MBSSID set beacon 514. The channel access delay of a primary beacon, such as single MBSSID set beacon 513, and of the associated Supplemental beacon, such as SB 523, may not affect the transmission time of the single MBSSID set beacon 514 and the Supplemental beacon SB 524.

There are two possible mechanisms to group VAPs in the Supplementary beacon:

a. Supplementary Beacons Per MBSSID Set Beacon.

Supplementary beacon(s) may be transmitted per MBSSID set beacon. The Supplementary beacon may capture additional IEs for VAPs belonging to the specific MBSSID set beacon. The TA of the Supplementary beacon may be the BSSID of the transmitted VAP. Although rare, there is a chance of multiple Supplementary beacons for a set of MBSSID set beacons. The offset and BSS identification present in the Supplementary Beacon IE informs the clients about the respective Supplementary beacon. The advantage of this approach is clean design and easy implementation for the clients to process each Supplementary beacon.

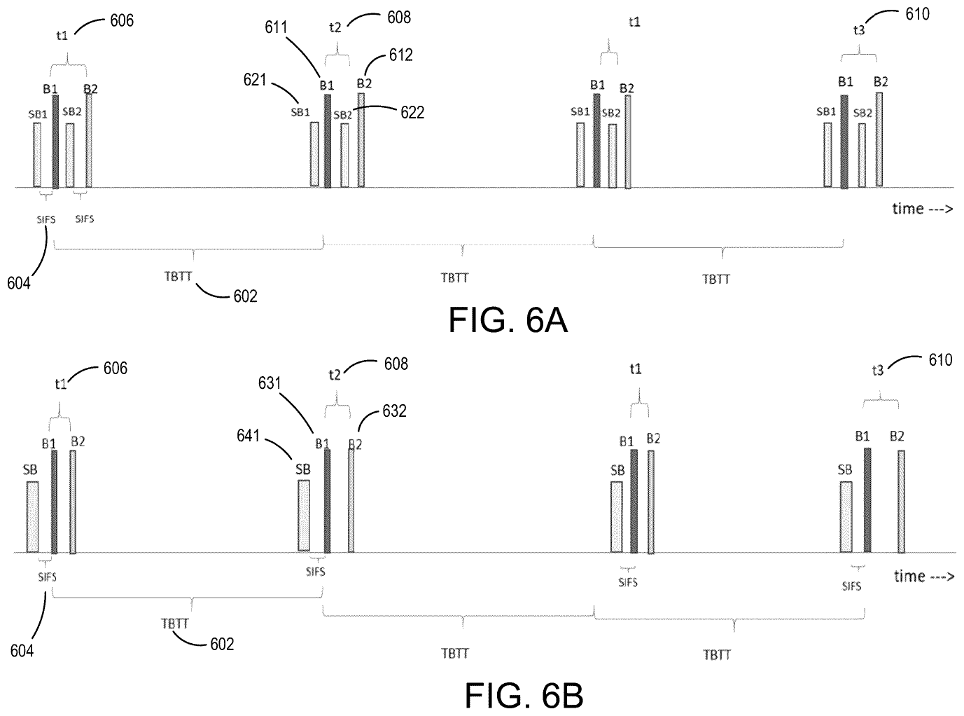

FIG. 6A illustrates an example of multiple MBSSID set beacons with a Supplementary beacon per MBSSID set beacon. More than one MBSSID set beacon may be used to transmit data to client devices of client vendors and stations when multiple VAPs of a radio are being advertised. Each MBSSID set beacon may be used to advertise multiple VAPs. The number of MBSSID set beacons may depend on the number of VAPs of the radio, and the total number of bytes of all of the VAPs of the radio. A single MBSSID set beacon may be used to transmit any number of VAPs as long as the total number of bytes of the VAPs is within a byte threshold. In some examples, the byte threshold of a single MBSSID set beacon is 1500 bytes. When the total number of bytes of all of the VAPs of a radio being advertised is greater than the byte threshold, then multiple MBSSID set beacons may be used to advertise all of the VAPs of the radio. All of the VAPs may be divided amongst multiple MBSSID set beacons, where each MBSSID set beacon is used for a different set of VAPs. Each of the multiple MBSSID set beacons may be used for a different set of VAPs, each having a total byte within the byte threshold.

For example, each primary beacon in FIG. 6A, such as beacon B1 611 and beacon B2 612 may be a MBSSID set beacon. Beacons B1 611 and B2 612 may be a first set of multiple MBSSID set beacons used to advertise all of the VAPs of the radio. The total amount of bytes for all of the VAPs may be 3000 bytes, with the bytes threshold for a MBSSID set beacon being at 1500 bytes. The total number of VAPs may be split up into two groups, with each group of VAPs having a total of 1500 bytes. The first group of VAPs may be transmitted by the MBSSID set beacon B1 611 and the second group of VAPs may be transmitted by the MBSSID set beacon B2 612.

A Supplemental beacon may be generated and used for each MBSSID set beacon. For example, a Supplemental beacon SB1 621 may be generated to support MBSSID set beacon B1 611 and Supplemental beacon SB2 622 may be generated to support MBSSID set beacon B2 612. The Supplemental beacon SB1 621 and SB2 622 may be transmitted at a set time interval, such as SIF 604, preceding the associated MBSSID set beacon B1 611 and B2 612, respectively, as shown in FIG. 6A.

In some examples, the time between the primary beacons B1 611 and B2 612 of a set of multiple MBSSID set beacons may be at different time intervals, t1 606, t2 608 or t3 610. In other examples, the time of t1 606, t2 608 and/or t3 610 may be at a set time interval, such as SIFS. The time intervals t1 606, t2 608 and t3 610 between beacon transmissions highlight the possibility of staggered beacons in sets of multiple MBSSID set beacons. The SIFS time interval between primary beacons B1 611 and B2 612 may be used for a bursted beacon approach. Each set of multiple MBSSID set beacons may comprise one or more MBSSID set beacons, such as B1 611 and B2 612, transmitted at set time intervals, such as TBTT 602, between each other set of multiple MBSSID set beacons. Many variations are possible.

Each Supplemental beacon, such as SB1 621 and SB2 622, may transmit data to one or more client devices in the network. The data transmitted by a Supplemental beacon may be a portion of the overall data to be transmitted by the associated primary beacons B1 611 and B2 612. The primary beacons B1 611 and B2 612 may be used to transmit data to legacy client devices. Legacy client devices may have limited capabilities to receive and/or process certain data, whether the data is too large or too complex for the legacy client devices to handle. Such large or complex data may cause legacy client devices to fail. The Supplemental beacons SB1 621 and SB2 622 may be used to separate data for newer client devices to allow all client devices to receive the data relevant to them while not causing any client devices to fail. Legacy devices may detect the transmitted VAPs of the primary beacons, such as B1 611 and B2 612, but will ignore the Supplemental beacons and any VAPs being transmitted by the Supplemental beacons. The newer client devices may process the Supplemental beacons and receive data and VAPs being transmitted by the Supplemental beacons.

b. A Single Supplemental Beacon Per Set of MBSSID Set Beacons.

A Supplementary beacon can advertise VAPs across multiple MBSSID set beacons. FIG. 6B illustrates a set of multiple MBSSID set beacons, with a Supplementary beacon per radio. B1 631 and B2 632 may be beacons corresponding to two MBSSID set beacons. Each MBSSID set beacon may be used to advertise multiple VAPs of the radio. The number of MBSSID set beacons per radio may depend on the number of VAPs of the radio, and the total number of bytes of all of the VAPs of the radio. A single MBSSID set beacon may be used to transmit any number of VAPs as long as the total number of bytes of the VAPs is within a byte threshold. In some examples, the byte threshold of a single MBSSID set beacon is 1500 bytes. When the total number of bytes of all of the VAPs of a radio being advertised is greater than the byte threshold, then multiple MBSSID set beacons may be used to advertise all of the VAPs of the radio. All of the VAPs may be divided amongst multiple MBSSID set beacons, where each MBSSID set beacon is used for a different set of VAPs. Each of the multiple MBSSID set beacons may be used for a different set of VAPs, each having a total byte within the byte threshold.

For example, each primary beacon in FIG. 6B, such as beacon B1 631 and beacon B2 632 may be a MBSSID set beacon. Beacons B1 631 and B2 632 may be a first set of multiple MBSSID set beacons used to advertise all of the VAPs of the radio. The total amount of bytes for all of the VAPs may be 3000 bytes, with the bytes threshold for a single MBSSID set beacon being at 1500 bytes. The total number of VAPs may be split up into two groups, with each group of VAPs having a total of 1500 bytes. The first group of VAPs may be transmitted by the MBSSID set beacon B1 631 and the second group of VAPs may be transmitted by the MBSSID set beacon B2 632.

A Supplemental beacon may be generated and used for each set of multiple MBSSID set beacon. For example, a Supplemental beacon SB1 641 may be generated to support the set of multiple MBSSID set beacons B1 631 and B2 632. Supplemental beacon SB 641 may advertise add-on information of VAPs belonging to a radio. The Supplemental beacon SB 641 may be transmitted at a set time interval, such as SIF 604, preceding the first MBSSID set beacon, such as B1 631, of the set of multiple MBSSID set beacons, as shown in FIG. 6B.

In some examples, the time between the primary beacons B1 631 and B2 632 of a set of multiple MBSSID set beacons may be at different time intervals, t1 606, t2 608 or t3 610. In other examples, the time of t1 606, t2 608 and/or t3 610 may be at a set time interval, such as SIFS. The time intervals t1 606, t2 608 and t3 610 between beacon transmissions highlight the possibility of staggered beacons in sets of multiple MBSSID set beacons. The SIFS time interval between primary beacons B1 611 and B2 612 may be used for a bursted beacon approach. Each set of multiple MBSSID set beacons may comprise one or more MBSSID set beacons, such as B1 611 and B2 612, transmitted at set time intervals, such as TBTT 602, between each other set of multiple MBSSID set beacons. Many variations are possible.

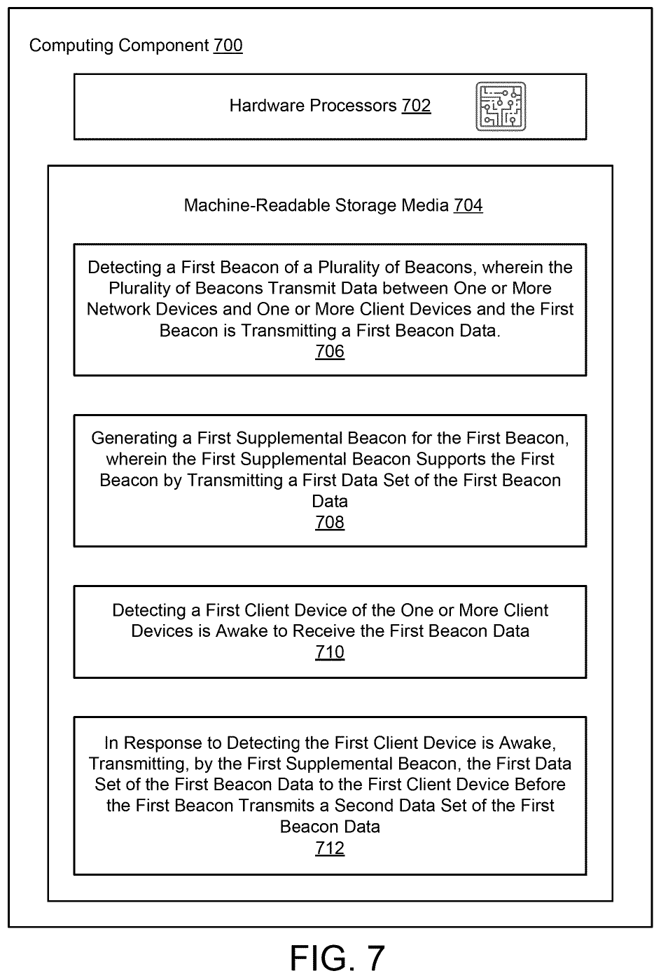

FIG. 7 illustrates an example computing component 700 that includes one or more hardware processors 702 and machine-readable storage media 704 storing a set of machine-readable/machine-executable instructions that, when executed, cause the hardware processor(s) 702 to perform an illustrative method for generating supplemental beacons in Wi-Fi networks in accordance with one example of the disclosed technology. Computing component 700 may be, for example, a server computer, a controller, or any other similar computing component capable of processing data. It should be appreciated that there can be additional, fewer, or alternative steps performed in similar or alternative orders, or in parallel, within the scope of the various examples discussed herein unless otherwise stated.

Hardware processor 702 may be one or more central processing units (CPUs), semiconductor-based microprocessors, and/or other hardware devices suitable for retrieval and execution of instructions stored in machine-readable storage medium 704. Hardware processor 702 may fetch, decode, and execute instructions, such as instructions 706-712, to control processes or operations for generating supplemental beacons. As an alternative or in addition to retrieving and executing instructions, hardware processor 702 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 704, may be any electronic, magnetic, optical, or other physical storage device that contains or stores executable instructions. Thus, machine-readable storage medium 704 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 704 may be a non-transitory storage medium, where the term “non-transitory” does not encompass transitory propagating signals. As described in detail below, machine-readable storage medium 704 may be encoded with executable instructions, for example, instructions 706-712.

Hardware processor 702 may execute instruction 706 to detect a first beacon of a plurality of beacons. The plurality of beacons, including the first beacon, may be primary beacons in a communication network. The plurality of beacons may be used transmit data between one or more network devices and one or more client devices. The one or more network devices may include an access point, router, switch, or gateway. The one or more client devices may comprise a computer, server, monitor, laptop, or phone.

The first beacon of the plurality of beacons may be used to transmit a first beacon data between one or more network devices and one or more client devices. The first beacon may be a Multiple Basic Service Set Identifier (MBSSID) beacon. The first beacon may include one or more Virtual Access Points (VAPs) of a radio in a communication network to be advertised. The number of VAPs of a radio in a communication network may determine the number of beacons in the plurality of beacons. A VAP may have a packet size of a particular number of bytes. The number of bytes in each VAP may vary according to the capabilities of the individual VAP. A primary beacon, such as the first beacon, may have a threshold of the number of bytes the primary beacon can transmit. If the total number of bytes of all of the VAPs of a radio in the communication network is greater than the threshold of a single primary beacon, then multiple primary beacons may be used to advertise all of the VAPs. The VAPs may be separated into various groups, where each group of VAPs has a total number of bytes that is within the threshold of bytes of a primary beacon. Each group of VAPs may be assigned to a primary beacon, such a the first beacon, where each primary beacon may advertise and transmit data from its respective group of VAPs to one or more network devices and/or one or more client devices.

Hardware processor 702 may execute instruction 708 to generate a first supplemental beacon for the first beacon. The first beacon may be used to transmit data to legacy devices of the one or more network devices and one or more client devices. Legacy devices may be devices that operate in 2.4 GHz and 5 GHz frequency bands. To prevent legacy devices from having to receive data that may exceed the capabilities of the legacy devices, a first supplemental beacon may be generated to support the first beacon.

The first supplemental beacon may support the first beacon by transmitting a first data set of the first beacon data to newer (“non-legacy”) devices. Newer devices may be devices that operate in the 6 GHz frequency band, which legacy devices are unable to operate in. Using a first supplemental beacon to support the first beacon, data may be separated between the first supplemental beacon and the first beacon to ensure that the correct data is being sent to the preferred devices. In this way, legacy devices may avoid being sent data that may exceed its capabilities. Legacy devices may ignore any supplemental beacons that are sending data and may only receive data from the primary beacons, such as the first beacon of the plurality of beacons.

The first supplemental beacon may be generated according to the number of VAPs in the first beacon. Based on the number of VAPs of a radio in the communication network, there may be more than a first beacon being used to transmit data between one or more network devices and one or more client devices. A VAP may have a packet size of a particular number of bytes. The number of bytes in each VAP may vary according to the capabilities of the individual VAP. A primary beacon, such as the first beacon, may have a threshold of the number of bytes the primary beacon can transmit.

If the total number of bytes of all of the VAPs of a radio in the communication network is greater than the threshold of a single primary beacon, then multiple primary beacons may be used to advertise all of the VAPs. The VAPs may be separated into various groups, where each group of VAPs has a total number of bytes that is within the threshold of bytes of a primary beacon. Each group of VAPs may be assigned to a primary beacon, such as the first beacon, where each primary beacon may advertise and transmit data from its respective group of VAPs to one or more network devices and/or one or more client devices. When multiple primary beacons are being used to advertise all of the VAPs of the radio, then more than one supplemental beacon may be generated to support all of the primary beacons. In addition, depending on the number and total number of bytes of all of the VAPs to be advertised, more than one supplemental beacon may be generated even if only one primary beacon is being used to advertise all of the VAPs. Many variations are possible.

Hardware processor 702 may execute instruction 710 to detect a first client device of the one or more client devices is awake to receive the first beacon data. A supplemental beacon may be generated to support at least a first primary beacon. The supplemental beacon may be used to transmit data to one or more network devices and/or one or more client devices. For a network device and/or client device to receive data from the supplemental beacon, the network device and/or client device may need to be awake. A device, such as network device or a client device, may transition between sleep mode and awake mode depending on whether the device is to receive data in the communication network. When a device is not to receive data, the device may be in sleep mode. A device may transition from sleep mode to awake mode when the time for the device to receive data from a beacon is reached, whether the beacon is a supplemental beacon and/or a primary beacon.

Hardware processor 702 may execute instruction 712 to transmit, by the first supplemental beacon, the first data set of the first beacon data to the first client device in response to detecting the first client device is awake. When a device, such as the first client device, is awake to receive data, a supplemental beacon, such as the first supplemental beacon, may transmit data to the device. A supplemental beacon, such as the first supplemental beacon, may transmit first data to a device at a time interval prior to when a primary beacon, such as the first beacon, transmits second data to the device. The time interval between when a supplemental beacon transmits data and when a primary beacon transmits data may be set in advance. The time interval may be a Short Interframe Space (SIFS) interval. A SIFS interval is a set duration of time that may be programmed in communication networks.

If additional supplemental beacons are generated to support one or more primary beacons, the additional supplemental beacons may also transmit data to the device following the transmission of data by the first supplemental beacon. The time interval between when a first supplemental beacon transmits data and when a second supplemental beacon transmits data may be set in advance. The time interval between supplemental beacons may be the same as the time interval between a supplemental beacon and a primary beacon. The time interval may be a Short Interframe Space (SIFS) interval.

In one example, when more than one supplemental beacon is generated to support one primary beacon, all of the supplemental beacons may transmit data to one or more client devices before the one primary beacon transmits data. In another example, when more than one supplemental beacon is generated to support more than one primary beacons, all of the supplemental beacons may transmit data to one or more client devices before any of the primary beacons transmit data. In another example, when more than one supplemental beacon is generated to support more than one primary beacons, a supplemental beacon may transmit data to one or more client devices before a primary beacon transmits data, where the beacons alternate between supplemental beacon and primary beacon transmitting data. The supplemental beacon may be associated to the primary beacon that follows. For example, if three supplemental beacons SB1, SB2 and SB3 are generated to support primary beacons PB1, PB2 and PB3, then the supplemental beacon SB1 may transmit data at a time interval prior to the primary beacon PB1 transmitting data, the supplemental beacon SB2 may transmit data at a time interval prior to the primary beacon PB2 transmitting data, and the supplemental beacon SB3 may transmit data at a time interval prior to the primary beacon PB3 transmitting data. The supplemental beacon SB1 may be associated to the primary beacon PB1, the supplemental beacon SB2 may be associated to the primary beacon PB2, and the supplemental beacon SB3 may be associated to the primary beacon PB3. Many variations are possible.

Devices, such as network devices and client devices, may be awake to receive data being transmitted from supplemental beacons and primary beacons. Devices may only receive data when in awake mode. A device may transition from awake mode to sleep mode after the device has received all of the data to be transmitted from the supplemental beacons and primary beacons. A device may transition from sleep mode to awake mode when time durations have been meet to receive data from a primary beacon and/or supplemental beacon. When a device becomes awake (transitions from sleep mode to awake mode) when the time to receive data from a supplemental beacon is reached, the device may remain awake (stay in awake mode) until after the device receives data from all of the supplemental beacons and primary beacons within a given session. Once a device receives all of the data being transmitted from supplemental beacons and primary beacons within a given session, the device may transition from awake mode to sleep mode. The device may remain in sleep mode until the next time period to receive data from a supplemental beacon or primary beacon is reached for the next session. When no devices are detected to be awake during a given time period of a session, supplemental beacons and/or primary beacons may not be able to transmit data. To conserve energy and increase efficiency, supplemental beacons and primary beacons may disengage and be placed into sleep mode when no devices are detected to be awake to receive data to be transmitted at a given time period of a session.

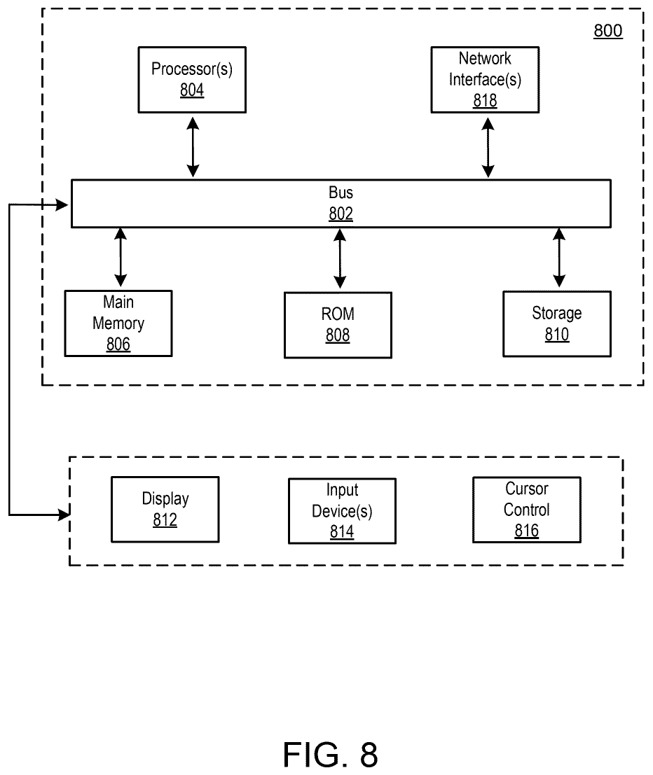

FIG. 8 illustrates a block diagram of an example computer system 800 in which various of the examples described herein may be implemented. For example, the functionality of one or more of the elements, network functions, etc. illustrated in any of FIGS. 1-7 may be implemented or effectuated by computer system 800. The computer system 800 includes a bus 802 or other communication mechanism for communicating information, one or more hardware processors 804 coupled with bus 802 for processing information. Hardware processor(s) 804 may be, for example, one or more general purpose microprocessors.

The computer system 800 also includes a main memory 806, such as a random access memory (RAM), cache and/or other dynamic storage devices, coupled to bus 802 for storing information and instructions to be executed by processor 804. Main memory 806 also may be used for storing temporary variables or other intermediate information during execution of instructions to be executed by processor 804. Such instructions, when stored in storage media accessible to processor 804, render computer system 800 into a special-purpose machine that is customized to perform the operations specified in the instructions.

The computer system 800 further includes a read only memory (ROM) 808 or other static storage device coupled to bus 802 for storing static information and instructions for processor 804. A storage device 810, such as a magnetic disk, optical disk, or USB thumb drive (Flash drive), etc., is provided and coupled to bus 802 for storing information and instructions.

The computer system 800 may be coupled via bus 802 to a display 812, such as a liquid crystal display (LCD) (or touch screen), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. In some examples, the same direction information and command selections as cursor control may be implemented via receiving touches on a touch screen without a cursor.

The computing system 800 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “system,” “database,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 800 may implement the techniques described herein using customized hard-wired logic, one or more ASICs or FPGAS, firmware and/or program logic which in combination with the computer system causes or programs computer system 800 to be a special-purpose machine. According to one example, the techniques herein are performed by computer system 800 in response to processor(s) 804 executing one or more sequences of one or more instructions contained in main memory 806. Such instructions may be read into main memory 806 from another storage medium, such as storage device 810. Execution of the sequences of instructions contained in main memory 806 causes processor(s) 804 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 810. Volatile media includes dynamic memory, such as main memory 806. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 802. Transmission media can also take the form of acoustic or light waves, such as those generated during radio-wave and infra-red data communications.

The computer system 800 also includes a communication interface 818 coupled to bus 802. Network interface 818 provides a two-way data communication coupling to one or more network links that are connected to one or more local networks. For example, communication interface 818 may be an integrated services digital network (ISDN) card, cable modem, satellite modem, or a modem to provide a data communication connection to a corresponding type of telephone line. As another example, network interface 818 may be a local area network (LAN) card to provide a data communication connection to a compatible LAN (or WAN component to communicate with a WAN). Wireless links may also be implemented. In any such implementation, network interface 818 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 818, which carry the digital data to and from computer system 800, are example forms of transmission media.

The computer system 800 can send messages and receive data, including program code, through the network(s), network link and communication interface 818. In the Internet example, a server might transmit a requested code for an application program through the Internet, the ISP, the local network and the communication interface 818. The received code may be executed by processor 804 as the code is received, and/or stored in storage device 810, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 800.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A computing system for supplemental beacons comprising:
one or more processors; and
a non-transitory computer readable medium including instructions that, when executed by the one or more processors, cause the one or more processors to perform operations comprising:
detecting a first beacon of a plurality of beacons, wherein the plurality of beacons transmit data between one or more network devices and one or more client devices, and the first beacon is transmitting a first beacon data;
generating a first supplemental beacon for the first beacon, wherein the first supplemental beacon supports the first beacon by transmitting a first data set of the first beacon data;
detecting a first client device of the one or more client devices is awake to receive the first beacon data; and
in response to detecting the first client device is awake, transmitting, by the first supplemental beacon, the first data set of the first beacon data to the first client device before the first beacon transmits a second data set of the first beacon data.

2. The computing system of claim 1, wherein the first beacon is a Multiple Basic Service Set Identifier (BSSID) beacon.

3. The computing system of claim 1, wherein the one or more network devices comprise an access point, router, switch, or gateway.

4. The computing system of claim 1, wherein the one or more client devices comprise a computer, server, monitor, laptop, or phone.

5. The computing system of claim 1, wherein the first supplemental beacon is transmitted Short Interframe Space (SIFS) before the first beacon.

6. The computing system of claim 1, wherein the first beacon comprises one or more Virtual Access Points (VAPs) to be advertised.

7. The computing system of claim 6, wherein the first supplemental beacon is generated according to a number of VAPs in the first beacon.

8. The computing system of claim 1, wherein the computer readable medium further comprises instructions that cause the one or more processors to perform operations further comprising:
determining a number of VAPs advertised in the first beacon is greater than a threshold;
in response to determining the number of VAPs is greater than a threshold, generate a second supplemental beacon for the first beacon, wherein the second supplemental beacon supports the first beacon by transmitting a third data set of the first beacon data; and
in response to detecting the first client device is awake, transmitting, by the second supplemental beacon after the first supplemental beacon and before the first beacon, the third data set of the first beacon data to the first client device.

9. The computing system of claim 1, wherein the computer readable medium further comprises instructions that cause the one or more processors to perform operations further comprising:
transmitting, by the first beacon, the second data set of the first beacon data.

10. The computing system of claim 1, wherein the computer readable medium further comprises instructions that cause the one or more processors to perform operations further comprising:
in response to not detecting the first client device is awake, disengaging the first beacon and the first supplemental beacon, wherein disengaging the first beacon and the first supplemental beacon places the first beacon and the first supplemental beacon in sleep mode.

11. The method for supplemental beacons comprising:
detecting a first beacon set of a plurality of beacon sets, wherein:
the first beacon set comprises one or more beacons;
each of the one or more beacons transmits data between one or more network devices and one or more client devices; and
the first beacon set is transmitting a first beacon set data;
generating a first supplemental beacon for the first beacon set, wherein the first supplemental beacon supports the first beacon set by transmitting a first data set of the first beacon set data;
detecting a first client device of the one or more client devices is awake to receive the first beacon data; and
in response to detecting the first client device is awake, transmitting, by the first supplemental beacon, the first data set of the first beacon data to the first client device before the first beacon transmits a second data set of the first beacon set data.

12. The method of claim 11, wherein each of the one or more beacons of the first beacon set comprises one or more Virtual Access Points (VAPs) to be advertised.

13. The method of claim 11, wherein each of the one or more beacons is a Multiple Basic Service Set Identifier (BSSID) beacon.

14. The method of claim 11, wherein the first supplemental beacon is transmitted Short Interframe Space (SIFS) before the first beacon set.

15. The method of claim 12, wherein the first supplemental beacon is generated according to a number of VAPs in the one or more beacons of the first beacon set.

16. The method of claim 11, further comprising:
determining a number of VAPs advertised in the one or more beacons of the first beacon set is greater than a threshold;
in response to determining the number of VAPs is greater than a threshold, generate a second supplemental beacon for the first beacon set, wherein the second supplemental beacon supports the first beacon set by transmitting a third data set of the first beacon data; and
in response to detecting the first client device is awake, transmitting, by the second supplemental beacon after the first supplemental beacon and before the first beacon, the third data set of the first beacon set data to the first client device.

17. The method of claim 11, further comprising:
transmitting, by the first beacon set, the second data set of the first beacon set data.

18. The method of claim 11, further comprising:
in response to not detecting the first client device is awake, disengaging the first beacon and the first supplemental beacon, wherein disengaging the first beacon and the first supplemental beacon places the first beacon and the first supplemental beacon in sleep mode.

19. A non-transitory computer-readable storage medium for supplemental beacons, configured with instructions executable by one or more processors to cause the one or more processors to perform operations comprising:
detecting one or more beacons, wherein the one or more beacons transmit beacon data between one or more network devices and one or more client devices;
generating a supplemental beacon for the one or more beacons, wherein the supplemental beacon supports the one or more beacons by transmitting a first data set of the beacon data;
detecting a first client device of the one or more client devices is awake to receive the beacon data; and
in response to detecting the first client device is awake, transmitting, by the supplemental beacon, the first data set of the beacon data to the first client device before a first beacon of the one or more beacons transmits a second data set of the beacon data.

20. The medium of claim 19, wherein the operations further comprise:
determining a number of Virtual Access Points (VAPs) advertised in the one or more beacons is greater than a threshold;
in response to determining the number of VAPs is greater than a threshold, generate a second supplemental beacon for the one or more beacons, wherein the second supplemental beacon supports the one or more beacons by transmitting a third data set of the beacon data; and
in response to detecting the first client device is awake, transmitting, by the second supplemental beacon after the first supplemental beacon and before the first beacon, the third data set of the beacon data to the first client device.
